(19) United States
(12) Patent Application Publication
(10) Pub. No.: US 2011/0035144 A1
(43) Pub. Date: Feb. 10, 2011

(54) NAVIGATION APPARATUS AND OPERATION PART DISPLAY METHOD

(75) Inventors: Keisuke Okamoto, Tokyo (JP); Kenya Yamada, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/922,593

(22) PCT Filed: Apr. 9, 2009
(86) PCT No.: PCT/JP2009/057279

§ 371 Date: Sep. 14, 2010

(30) Foreign Application Priority Data
Apr. 14, 2008 (JP) 2008-104733

(51) Int. Cl. G01C 21/00

(52) U.S. Cl. 701/200

(57) ABSTRACT

A navigation apparatus which accepts an operation of an operation button displayed on a display part, the navigation apparatus including: a vehicle operation detector detecting a vehicle operation when the vehicle travels; a driver characteristics learning mechanism learning driver characteristics of a driver based on the driver operation information; and a display manner changing mechanism changing a display manner of the operation button according to a learning result of the driver characteristics learning mechanism.

### TECHNICAL FIELD

The present invention is related to a navigation apparatus, etc., in particular, a navigation apparatus and an operation part display method which changes a display manner of an operation button displayed on a display part.

### BACKGROUND ART

A touch panel functioning as a display part and an operation part is used as an interface of a navigation apparatus, which minimizes the hardware-based operation part such as a keyboard to improve space utilization, and improves operability such as enabling operations through intuition. With respect to the touch panel, JP2006-17478 A proposes a navigation apparatus in which operation buttons formed in the touch panel are enlarged during traveling to improve the operability during traveling. In it, it is described that if the operation buttons are enlarged during traveling, it is possible to reduce operating errors.

Further, JP 2000-283771 A proposes a navigation apparatus in which an own vehicle icon which the navigation apparatus displays can be changed. The navigation apparatus disclosed in JP 2000-283771 A displays an anthropometric own vehicle icon according to driving characteristics of a driver such as a preference for high speed traveling, or displays the grown anthropometric own vehicle icon.

Since the navigation apparatuses are advanced rapidly, it is becomes more difficult to improve the operability by merely enlarging the operation buttons during traveling. For example, enlarging the operation buttons depending on a vehicle status only, as is the case with the navigation apparatus disclosed in JP2006-17478 A, means that the same user interface is provided to a skilled driver and an unskilled driver. Thus, there is a problem that the operability is not necessarily improved for every driver.

In this connection, the navigation apparatus disclosed in JP 2000-283771 A detects the driver characteristics to change the own vehicle icon; however, the change of the own vehicle icon possibly provides a performance effect suited for every driver but doesn't improve the operability.

### DISCLOSURE OF INVENTION

Therefore, it is an object of the present invention to provide a navigation apparatus and an operation part display method which can improve operability for the respective drivers according to the characteristics of the drivers.

In terms of the aforementioned objects, the present invention relates to a navigation apparatus which accepts an operation of an operation button displayed on a display part, said navigation apparatus comprising:

vehicle operation detecting means for detecting a vehicle operation at the time of traveling;

vehicle operation obtaining means for obtaining driver operation information based on the vehicle operation (including a navigation operation) which the vehicle operation detecting means detects;

driver characteristics learning means for learning driver characteristics of a driver based on the driver operation information; and

display manner changing means for changing a display manner of the operation button according to a learning result of the driver characteristics learning means.

According to the present invention, since the operation buttons can be customized according to the characteristics of the drivers, it is possible to improve operability for the respective drivers.

Further, in an embodiment of the present invention, the navigation apparatus further comprises vehicle circumstance detecting means for detecting a vehicle circumstance at the time of traveling; and circumstance information obtaining means for obtaining vehicle circumstance information based on the vehicle circumstance which the vehicle circumstance detecting means detects, wherein the driver measurement learning means learns the driver characteristics of the driver based on the driver operation information in a predetermined vehicle circumstance.

According to the present invention, since the driver characteristics can be learned in such a manner that they are associated with a traveling circumstance of the vehicle, it is possible to customize the operation buttons to suite every traveling circumstance.

According to the present invention, it is possible to provide a navigation apparatus and an operation part display method which can improve operability for the respective drivers according to the characteristics of the drivers.

### BRIEF DESCRIPTION OF DRAWINGS

FIG. 1 is a diagram for illustrating an example of an HMI of a navigation apparatus;

FIG. 2 is a block diagram of an example of the navigation apparatus;

FIG. 3A is a diagram for illustrating an example of a driver characteristic of “a degree of momentary lapses of attention” learned from the navigation operations;

FIG. 3B is a diagram for illustrating an example of a driver characteristic of “a degree of momentary lapses of attention” learned at the time of decelerating;

FIG. 3C is a diagram for illustrating an example of a driver characteristic of “a degree of momentary lapses of attention” learned at the time of operating of front lamps;

FIG. 4A is a diagram for illustrating an example of a driver characteristic of “a degree of haste” learned at the time of steering;

FIG. 4B is a diagram for illustrating an example of a driver characteristic of “a degree of haste” learned from a vehicle speed;

FIG. 4C is a diagram for illustrating an example of a driver characteristic of “a degree of haste” learned at the time of decelerating;

FIG. 4D is a diagram for illustrating an example of a driver characteristic of “a degree of haste” learned at the time of stopping of the vehicle;

FIG. 5A is a diagram for illustrating an example of a limit level table which defines a relationship between a current learning value of a degree of momentary lapses of attention or a degree of haste and a limit level;

FIG. 5B is a diagram for illustrating an example of an HMI definition table which defines a relationship between a limit level and an operation button to be displayed (operation limitation during driving: operation buttons A, D and E);

FIG. 5C is a diagram for illustrating an example of an HMI definition table which defines a relationship between a limit level and an operation button to be displayed (operation limitation during driving: operation buttons A, B, C, D and E);

FIG. 6 is a diagram for schematically showing an example of a relationship between the number of buttons and the HMI;

FIG. 7A is a flowchart of an example of a procedure by which the navigation apparatus learns the driver characteristics; and

FIG. 7B is a flowchart of an example of a procedure by which the HMI is customized.

### EXPLANATION FOR REFERENCE NUMBER

11 operation part
12 ECUs
13 sensors
14 position obtaining part
20 control part
21 driver operation information obtaining part
22 circumstance information obtaining part
23 driver characteristics learning part
24 HMI generating part
25 driver characteristics database
28 display part

### BEST MODE FOR CARRYING OUT THE INVENTION

In the following, the best mode for carrying out the present invention will be described in detail by referring to the accompanying drawings.

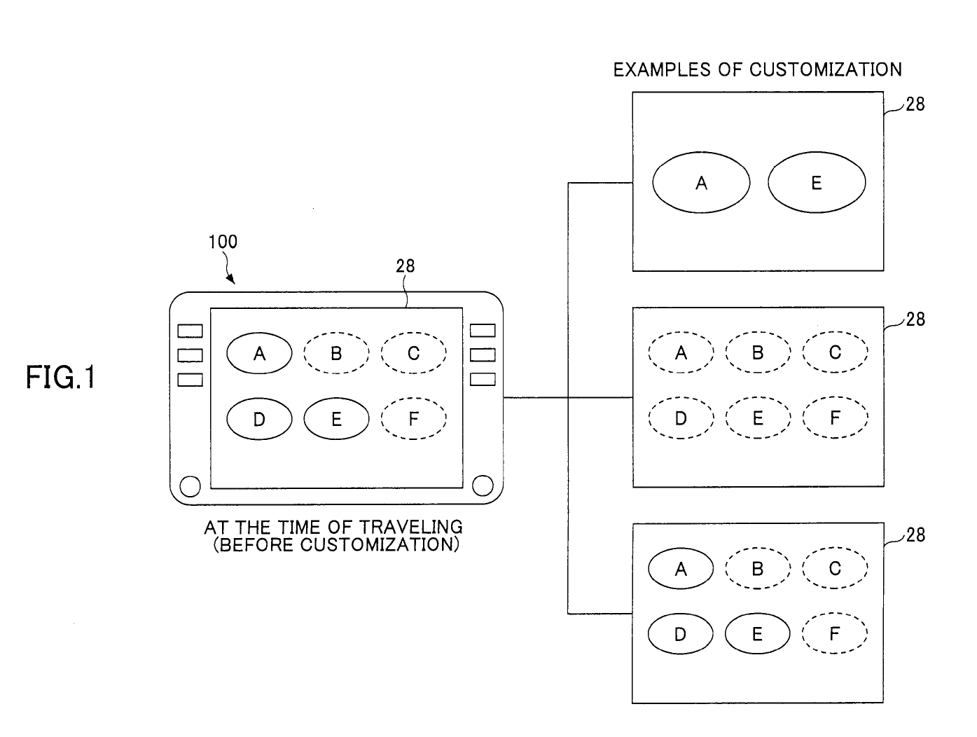

FIG. 1 is a diagram for illustrating an example of an HMI (Human Machine Interface) of a navigation apparatus 100 displayed during traveling. This HMI is displayed on a display part 28 including a touch panel. The navigation apparatus 100 provides functions corresponding to operation buttons A-F (merely referred to as operation button(s) when a distinction between them is not of importance, hereafter); however, in order to reduce the load of a driver by limiting complicated operations during driving, only the operation buttons A, D and E are operable. Hereafter, reducing the number of the operation buttons which are operable during driving is referred to as “operation limitation during driving”. It is noted that while the vehicle stops, all the operation buttons A-F are operable. Whether the vehicle stops is determined by at least one of the factors that a parking brake is in its ON state and that a vehicle speed is zero.

In the present embodiment, whether to permit these three operation buttons A, D and E to be displayed, an arrangement, a size, a luminance, and a color of these three operation buttons A, D and E (merely referred to as a display manner, hereafter) are changed according to driver characteristics. The display manner shown in a right upper portion of FIG. 1 is adopted for a driver who tends to make a mistake in navigation operations, for example, the display manner shown in a right middle portion of FIG. 1 is adopted for a driver who tends to fall into momentary lapses of attention, for example, and the display manner shown in a right lower portion of FIG. 1 is adopted for a driver who keeps one's cool, for example.

With this arrangement, it is possible to customize the display manner on a driver basis so as to improve operability. For example, for the driver who tends to make a mistake in operations of the navigation apparatus 100 (referred to as navigation operations, hereafter), as shown in a right upper portion of FIG. 1, only the operation buttons A and E which provide fundamental functions are displayed in the HMI. Further, by displaying the operation buttons A and E in larger sizes or enlarging the effective area of the operation buttons A and E beyond the outer boundary of the operation buttons A and E, it is possible even for the driver who tends to make a mistake in navigation operations, to easily operate them.

Further, for the driver who tends to fall into momentary lapses of attention (for example, the driver who performs harsh braking frequently), as shown in a right middle portion of FIG. 1, it is possible to prohibit all the operations of the operation buttons A, D and E during driving. The navigation apparatus 100 displays the operation buttons A, D and E in a lesser tone (i.e., reduces their luminance or chroma) or deletes them from the HMI, and thus doesn't provide their function even if the driver operates them. Therefore, it is possible to reduce the operation load of the driver who falls into momentary lapses of attention during driving.

Further, for example, for the driver who keeps one's cool, the HMI is provided without any customization. Therefore, the cool driver can operate the navigation apparatus 100 without any limitation. Further, for the driver who keeps one's cool, more operation buttons than those operable due to the operation limitation during driving may be made operable by relaxing the operation limitation during driving. For example, if the operation buttons A, D and E are operable before the customization, the operation button B, etc., may be made operable. The operation limitation during driving is set in terms of safety first, and thus the operation limitation during driving may be too strict for the cool driver. However, according to the present embodiment, since the operation limitation during driving can be relaxed, it is possible to improve the operability for the drivers.

It is noted that since even for the same driver the driver characteristics changes due to a mental state, physical condition, habituation of driving, etc., the navigation apparatus 100 according to the present embodiment can dynamically customize the HMI according to the change in the driver characteristics of the same driver while learning the driver characteristics whenever necessary.

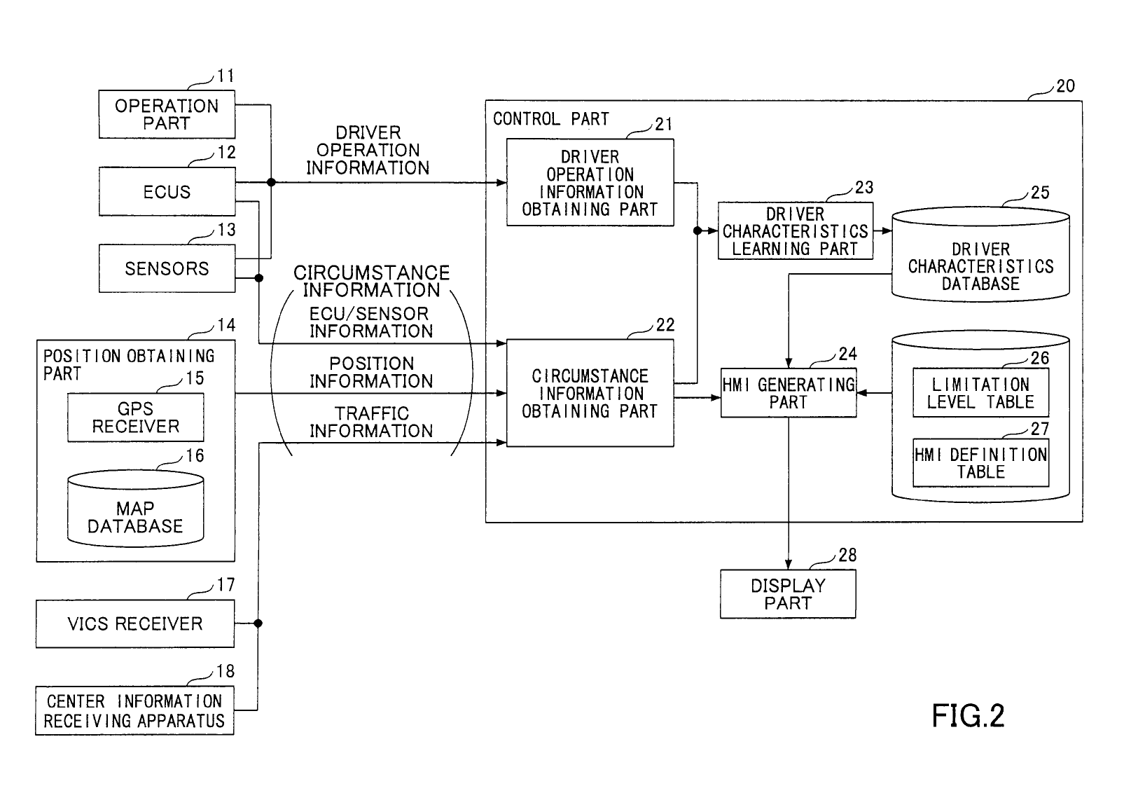

FIG. 2 is an example of a function block diagram of the navigation apparatus 100. In FIG. 2, the function block diagram is shown in a process for learning the driver characteristics and generating the HMI according to the driver characteristics. The navigation apparatus 100 is controlled by a control part 20. The control part 20 is connected to an operation part 11 for operating the navigation apparatus 100, ECUs (Electronic Control Units) 12 for controlling vehicle-mounted apparatuses, sensors 13 for detecting states of the vehicle, a position obtaining part 14 for obtaining the current vehicle position information, a VICS receiver 17 for receiving traffic information distributed by a VICS (Vehicle Information and Communication System), a center information receiving apparatus 18 for receiving traffic information from a probe car center (a server which generates traffic information from probe information collected from probe cars and distributes it), and a display part 28 for displaying the operation buttons.

Further, the substance of the control part 20 is a computer which has a CPU, a RAM, a nonvolatile memory, an ASIC (Application Specific Integrated Circuit), an input/output interface, etc. A driver operation information obtaining part 21, a circumstance information obtaining part 22 and a driver characteristics learning part 23 are implemented by the CPU executing programs or a hardware resource such as the ASIC, etc. The substance of the nonvolatile memory is a HDD (Hard disk drive) or a SSD (Solid State Drive), for example. The nonvolatile memory includes a driver characteristics database 25 for storing the driver characteristics and stores a limitation level table 26 and a HMI definition table 27. It is noted that the display part 28 is a flat panel display such as a liquid crystal or organic electro-luminescence panel, etc., in which a touch panel is installed.

The operation part 11 includes at least one of the operation buttons A-E formed in the HMI shown in FIG. 1, a keyboard provided around the HMI, a remote controller, a microphone and a speech recognition apparatus. Since the operation buttons A-E are displayed on the display part 28, the operation part 11 is partially overlapped with the display part 28.

Driver operation information of the navigation apparatus 100 is detected from the navigation operations in the operation part 11. Further, the ECUs 12 and the sensors 13 obtain the driver operation information of the driver other than the navigation operations. The fundamental vehicle operations of the vehicle include a steering operation, accelerating and decelerating operations and other vehicle operations include a winker (blinker) operation, a wiper operation, a parking brake operation, etc. The ECUs 12 and the sensors 13 obtain the driver operation information related to such vehicle operations. Thus, the ECUs 12 are a power steering ECU, an EFI-ECU, a brake ECU, a body ECU, etc. Further, the sensors 13 are a steering angle sensor, an accelerator pedal sensor, an acceleration sensor, a winker switch, a wiper switch, a parking brake switch, etc.

The navigation operations are included in the vehicle operations since the navigation operations are one embodiment of the vehicle operations; however, in the present embodiment, for the purpose of explanation, the navigation operations for operating the navigation apparatus 100 and the vehicle operation for operating the winker, etc., are distinguished from each other. The driver operation information can be as follows, for example.

[Acquisition of Driver Operation Information]

a) The navigation operations of the navigation apparatus 100 from the operation part 11 are detected. The driver operation information obtaining part 21 stores a series of operation information items of the operation buttons, detects mistakes in the navigation operations of the driver based on a “return” operation, touch miss (i.e., touch on non-effective areas of the operation buttons), etc., and obtains them as the driver operation information.

b) The ECUs 12 and the sensors 13 detects that the wheels of the vehicle are steered based on the steering angle of the steering wheel, and the driver operation information obtaining part 21 obtains the driver operation information at the time of cornering based on the vehicle speed, the yaw rate, and the acceleration in a transverse direction which are detected by the ECUs 12 and the sensors 13.

c) The ECUs 12 and the sensors 13 detects that the vehicle is operated to accelerate based on the amount the accelerator pedal is pressed down, for example, and the driver operation information obtaining part 21 obtains the driver operation information at the time of accelerating based on the acceleration, the vehicle speed, etc., which are detected by the ECUs 12 and the sensors 13.

d) The ECUs 12 and the sensors 13 detect that the vehicle is operated to decelerate based on the ON state of the stop lamp switch, for example, and the driver operation information obtaining part 21 obtains the driver operation information at the time of decelerating based on the deceleration, the pressure in the master cylinder, etc., which are detected by the ECUs 12 and the sensors 13.

e) Since at the time of operating the winker (the winker lever) the ECUs 12 and the sensors 13 detect the time from operating the winker switch to the steering operation, the vehicle speed and the steering angle, the driver operation information obtaining part 21 obtains the driver operation information at the time of changing the lane and turning right or left based on these detected values. For example, such driver operation information is obtained; the time from turning on the winker lamp to changing the lane is short, the driver changes the lane without turning on the winker lamp, etc.

f) Since at the time of operating the wiper, the ECUs 12 and the sensors 13 detect the amount of raindrops and the operated position of the wiper switch (Hi, Low and Int), the driver operation information obtaining part 21 obtains the driver operation information at the time of raining based on these detected values. For example, such driver operation information is obtained; the time from detecting the raindrops to turning on the wiper is long, and the time from not detecting the raindrops to stopping the wiper is long.

g) Since the ECUs 12 and the sensors 13 detect the ON/OFF state of the parking brake and the shift lever position when the vehicle speed becomes zero, the driver operation information obtaining part obtains the driver operation information at the time of stopping the vehicle, such as whether the driver turns on the parking brake at the time of stopping the vehicle, based on these detected values.

h) If a hands free apparatus is installed, the ECUs 12 and the sensors 13 detect the frequencies of responding to an incoming call, responding in a manner mode (i.e., a drive mode) or originating a call. The driver operation information obtaining part 21 obtains the driver operation information related to the hands free apparatus based on these detected values. It is possible to determine whether the driver is likely to lose attention based on the driver operation information related to the hands free apparatus, etc.

i) Further, a degree of awakening can be obtained as the driver operation information though this is not direct driver operation information of the driver. The ECUs 12 and the sensors 13 (a camera for imaging the face of the driver) detect a direction of line of sight and sleepiness of the driver during driving, and the driver operation information obtaining part 21 detects a status in which the direction of line of sight is stagnated the driver falls into an aimless driving status or the driver becomes sleepy (referred to as lowering the degree of awakening, hereafter), as the driver operation information.

[Acquisition of Circumstance Information]

The circumstance information is for matters which occur commonly for all the drivers regardless of the presence or absence of the driver operations. For example, there are a traffic jam, the climate, waiting at a traffic light, passing of a particular location or road, etc.

I) The VICS receiver 17 receives the traffic information including the presence or absence of a traffic jam, travel time of a link, etc., which the VICS distributes via FM broadcasting, radio beacons or optical beacons. Further, the center information receiving apparatus 18 receives the traffic information by connecting to a communication network of a mobile phone, etc. The traffic information which the VICS distributes is related to main highways only, while the traffic information which the probe car center may include information related to roads the vehicle passes. Thus, it is possible to receive traffic information related to a wider area. It is noted that the traffic information which the VICS receiver 17 receives and the traffic information which the center information receiving apparatus 18 receives are not completely the same; however, in this embodiment, there is no discrimination between the traffic information which the VICS receiver 17 receives and the traffic information which the center information receiving apparatus 18 receives. The circumstance information obtaining part 22 obtains the traffic information as the circumstance information.

II) The sensors 13 obtain climate information. In this case, the sensors 13 are a communication apparatus which connects to the server for distributing the climate information, for example, a raindrop sensor, an external temperature sensor, a solar radiation sensor, etc. It is noted that since in Japan the Japan Meteorological Agency provides AMeDAS (Automated Meteorological Data Acquisition System) information, the circumstance information obtaining part 22 obtains circumstance information such as an amount of precipitation, snow accumulation, a wind direction, an air temperature, a duration of bright sunshine, etc., which are included in the AMeDAS information.

III) The sensors 13 detect information related to time, day, etc. In this case, the sensors are a clock and a calendar. The circumstance information obtaining part 22 obtains circumstance information during daytime, night, midnight, dawn, week days, holidays, etc.

IV) Waiting at a traffic light, an intersection, particular locations/roads (a bridge, a railroad crossing, etc.), etc., are the circumstance information which is detected from the position of the vehicle. The position obtaining part 14 has a GPS receiver 15 and a map database 16. The GPS receiver 15 detects the current position of the vehicle (latitude, longitude and altitude) based on arrival time of the radio waves which the GPS receiver 15 receives from the GPS satellites. In the map database 16 nodes which delimit roads at intersections or a predetermined distance are stored associated with their position information. The road network is expressed by connecting the nodes with links which corresponds to the roads. Since in the map database 16 information for detecting intersections, bridges, tunnels, railroad crossings, coasts, mountain-ringed regions, etc., is stored, circumstance information is detected based on the position of the vehicle. The circumstance information obtaining part 22 obtains the circumstance information such as waiting at traffic light, an intersection, particular locations/roads, etc., based on the position of the vehicle.

[Learning of Driving Characteristics]

The driver characteristics learning part 23 learns the driver characteristics based on the driver operation information and the circumstance information. The driver characteristics may be learned for every combination of the driver operation information a)-i) and the circumstance information I)-IV). The driver characteristics learning part 23 learns the driver characteristics obtained for every combination of these factors. It is noted that since there is a case where plural drivers share the use of a vehicle, the driver characteristics are learned on a key ID basis, for example.

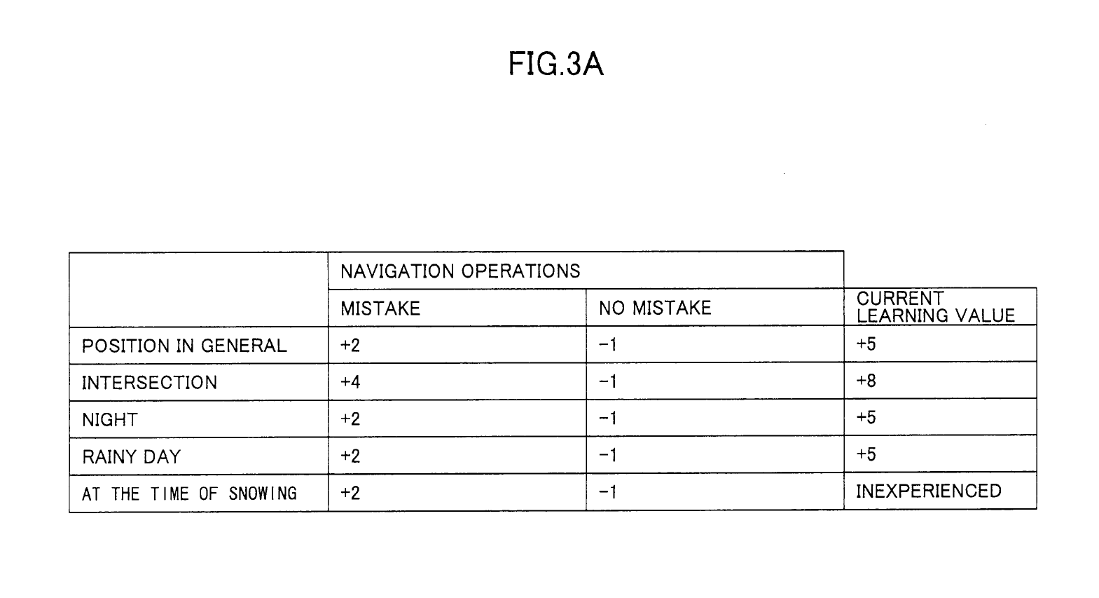

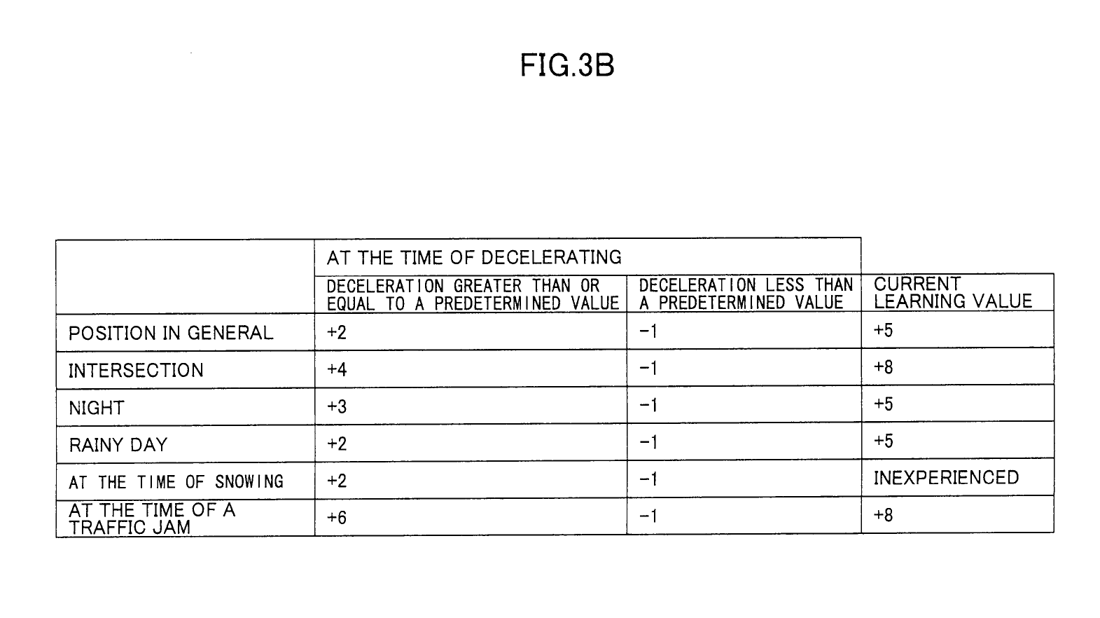

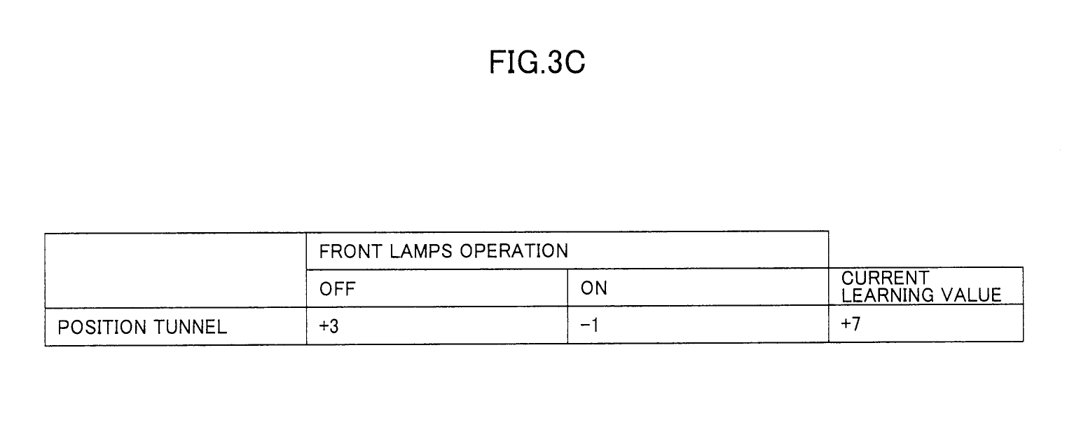

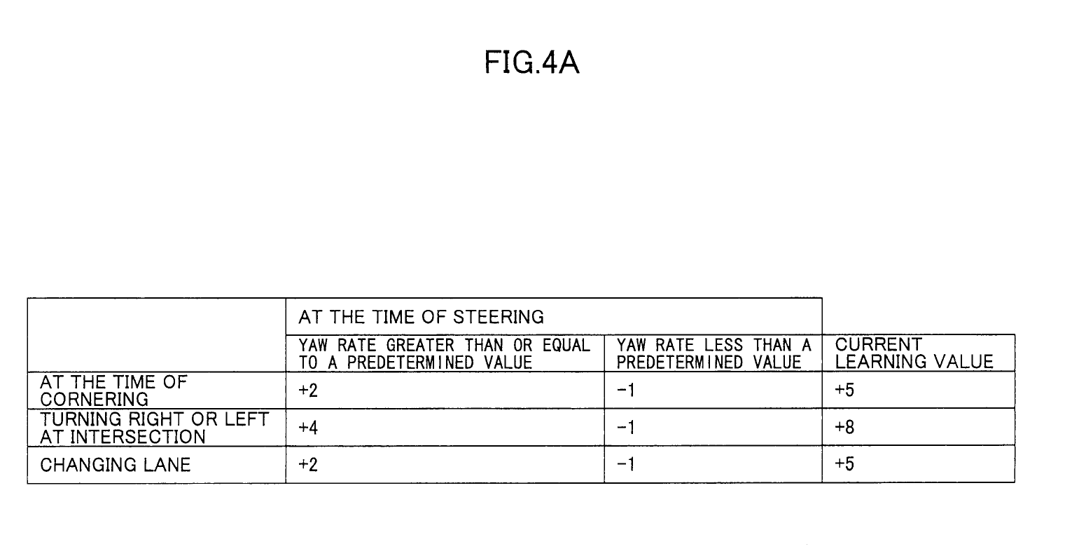

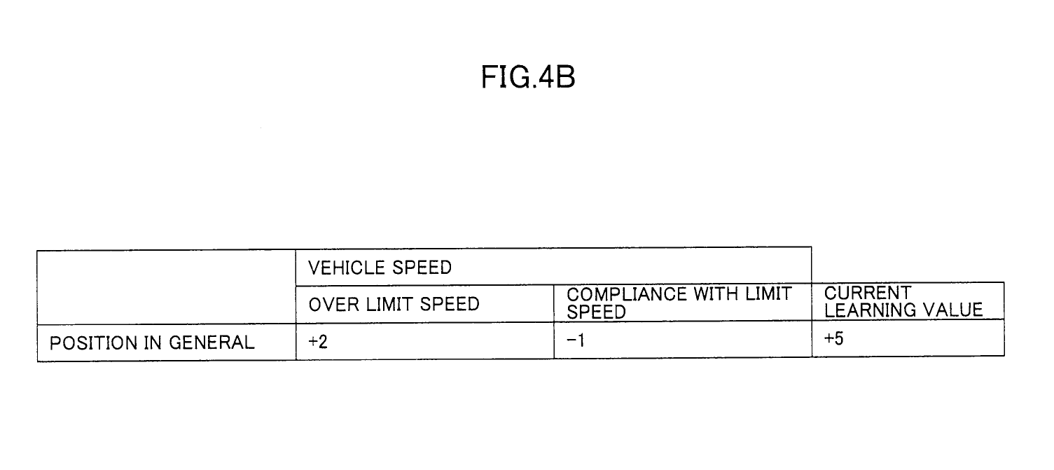

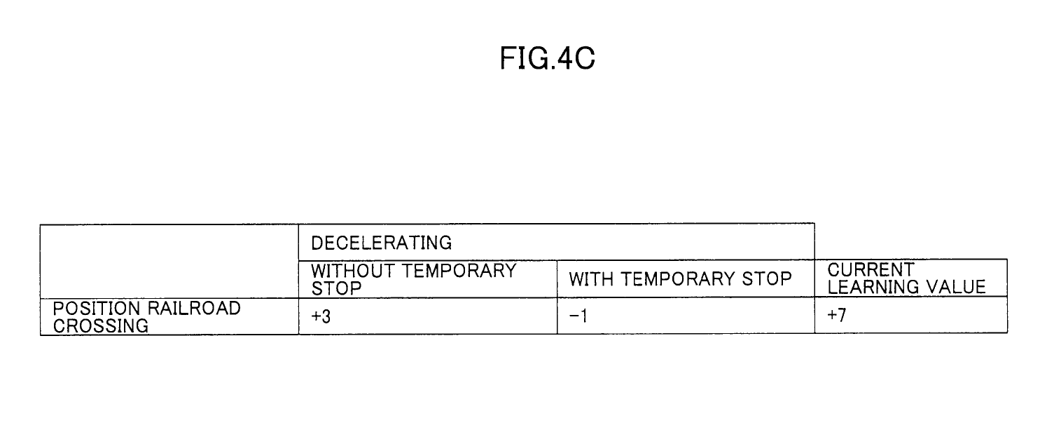

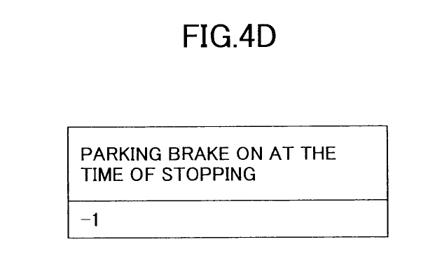

FIGS. 3A-3C and FIGS. 4A-4D show an example of the driver characteristics stored in the driver characteristics database 25. FIGS. 3A-3C and FIGS. 4A-4D show an extracted part of the learned driver characteristics in which as an example of the driver characteristics the degree of momentary lapses of attention and the degree of haste of the driver are learned. The greater these values are, the more likely the driver falls into the momentary lapses of attention or in haste, resulting in more limitation on the HMI as described below.

FIG. 3A is a diagram for illustrating an example of a driver characteristic of “a degree of momentary lapses of attention” learned from navigation operations. In other words, FIG. 3A shows an example of the degree of momentary lapses of attention learned based on the mistakes in the navigation operations. If there is a mistake in the navigation operations, more time is taken to complete desired navigation operations. This is thought to induce less attention for driving. For this reason, a learning amount at the time of operating the navigation screens is set according to whether the user makes a mistake in the navigation operations or not. Further, the learning amount varies according to the circumstance information because the attention to be paid varies according to the circumstance information such as an intersection in which a situation changes rapidly, nighttime during which visibility is reduced, etc. For example, if the user makes a mistake in navigation operation during driving at the intersection, the degree of momentary lapses of attention is incremented by “4”. The current degree of momentary lapses of attention obtained as a result of learning is stored as a current learning value. The current learning value is referred to in customizing the display manner of the HMI at a subsequent time.

FIG. 3B is a diagram for illustrating an example of a driver characteristic of “a degree of momentary lapses of attention” learned at the time of decelerating. In other words, FIG. 3B is a diagram for illustrating an example of a learning amount of a degree of momentary lapses of attention learned at the time of decelerating. If the deceleration at the time of decelerating is great, it can be estimated that the timing of starting the deceleration is deferred in as situation where the vehicle should be stopped or decelerated. For this reason, the learning amount of the degree of momentary lapses of attention at the time of decelerating is set according to whether the deceleration is greater than or equal to a predetermined value or not. Further, from decelerating the vehicle at the intersection with great deceleration, it can be estimated that the driver does not notice the pedestrian's crossing, the displayed information of the traffic signal, etc., at the last minute. Thus, the learning amount of the degree of momentary lapses of attention is greater than in other general locations. Similarly, from decelerating the vehicle with great deceleration during driving in a traffic jam or at the end of the traffic jam, it can be estimated that the driver does not notice the traffic jam ahead of the own vehicle. Thus, the learning amount of the degree of momentary lapses of attention is greater.

FIG. 3C is a diagram for illustrating an example of a driver characteristic of “a degree of momentary lapses of attention” learned at the time of operating of the front lamps. In other words, FIG. 3C shows an example of the degree of momentary lapses of attention learned based on the operations of the front lamps. During driving in the tunnel, the front lamps are required to be turned on according to statute, depending on the nation. If the driver does not turn on the front lamps during driving in the tunnel, it can be estimated that the attention to the traveling circumstance is reduced. For this reason, the learning amount of the degree of momentary lapses of attention based on the operations of the front lamps is set according to whether the driver turns on the front lamps or not during driving in the tunnel.

Additionally, when the degree of awakening is reduced, it may be estimated that the momentary lapses of attention occur. Thus, if the degree of awakening is reduced, the learning amount of the degree of momentary lapses of attention may be incremented (in a positive direction). With this arrangement, it is possible to limit the HMI if the degree of awakening is low. It is noted that instead of detecting the degree of awakening only, the degree of awakening may be detected in addition to the driver operation information at the time of the navigation operations, decelerating, operating of front lamps, etc. In this case, the degree of momentary lapses of attention may be learned if the degree of awakening is low, or the learning amount of the degree of momentary lapses of attention may be incremented (in a positive direction) if the degree of awakening is low. In terms of the fact that the momentary lapses of attention may occur depending on the degree of awakening, it is possible to appropriately learn the degree of momentary lapses of attention by learning the degree of awakening as well as the degree of momentary lapses of attention.

FIG. 4A is a diagram for illustrating an example of a driver characteristic of “a degree of haste” learned at the time of steering. In other words, FIG. 4A is a diagram for illustrating an example of a learning amount of a degree of haste learned at the time of steering. The degree of haste is an index which is detected based on the vehicle operations and represents a mental status which may occur when the driver is excessively in haste to reach a destination or in haste while waiting at traffic light. The degree of the momentary lapses of attention may be detected based on the same vehicle operations; however, in the present embodiment these are discriminated for the sake of convenience.

The driver steers at the time of cornering at curves, etc, turning right or left at the intersection, changing the lane, etc. If a yaw rate is great at the time of steering, it can be estimated that the steering of the vehicle is performed in a steep manner. For this reason, the learning amount of the degree of haste at the time of steering is set according to whether the yaw rate is greater than or equal to a predetermined value or not. It is noted that whether the steering of the vehicle is performed in a steep manner may be determined based on the acceleration in a transverse direction, a roll angle, etc., instead of the yaw rate. Further, since the raw rate at which it can be determined that the steering of the vehicle is performed in a steep manner is different between at the time of cornering at curves, turning right or left at the intersection, and changing the lane, the “predetermined value” may be varied according to the respective traveling circumstances.

FIG. 4B is a diagram for illustrating an example of a driver characteristic of “a degree of haste” learned from the vehicle speed. In other words, FIG. 4B is a diagram for illustrating an example of a learning amount of a degree of haste learned based on the vehicle speed. If the vehicle speed exceeds a speed limit, it can be estimated that the driver falls in a mental status where the driver wants to arrive at the destination immediately. For this reason, the learning amount of the degree of haste is set according to whether the driver complies with the speed limit or not. It is noted that since a sense for the speed limit differs depending on the nationality or culture, the speed limit itself is not necessarily used. For example, the degree of haste may be learned with reference to eighty percent of the speed limit or 1.2 times of the speed limit.

FIG. 4C is a diagram for illustrating an example of a driver characteristic of “a degree of haste” learned at the time of decelerating. In other words, FIG. 4C is a diagram for illustrating an example of a learning amount of a degree of haste learned based on the deceleration at the time of driving at a railroad crossing. In some nations, a temporary stop before crossing the railroad crossing is mandatory. If the driver does not perform the temporary stop before crossing the railroad crossing, it can be estimated that the driver falls in a mental status where the driver wants to arrive at the destination immediately. For this reason, the learning amount of the degree of haste is set according to whether the driver performs the temporary stop before crossing the railroad crossing or not, that is to say, whether the vehicle speed becomes zero or not.

Additionally, if the acceleration at the time of accelerating is great, it can be estimated that the driver falls in a mental status where the driver wants to arrive at the destination immediately. Thus, the learning amount of the degree of haste may be set whether the acceleration is greater than or equal to a predetermined value or not.

FIG. 4D is a diagram for illustrating an example of a driver characteristic of “a degree of haste” learned at the time of stopping of the vehicle. If the driver operates the parking brake into its ON state after stopping the vehicle, it can be estimated that the driver keeps cool in driving the vehicle. Thus, in the driver characteristics database 25 the learning amount which reduces the degree of momentary lapses of attention and the degree of haste is stored associated with such vehicle operations based on which the cool mental status can be presumed. For example, if the parking brake is operated into its ON state, the learning amount is decremented from the respective degree of momentary lapses of attention and haste.

Further, it is possible to register a special traveling circumstance such as snowing as shown in FIGS. 3A-3C. When it snows, the slip of the vehicle occurs easily and visibility becomes poor, etc., resulting in increase in the load of driving. Further, if the driver has not ever driven at the time of snowing, it may effect the operations of the navigation apparatus 100. Therefore, if the not experienced traveling circumstance is detected, it is possible to reduce the operation load of the driver by prohibiting all the operations of the operation buttons as is the case of the degree of momentary lapses of attention and haste being high.

A learning speed is described. The learning speed of the navigation apparatus 100 can be adjusted according to how frequently the learning amount is increased or decreased. For example, in the case of learning at the time of decelerating, if the current learning value is increased or decreased whenever the deceleration greater than or less than a predetermined value is detected, the driver operation information of the driver can be learned immediately. In this case, the HMI can be customized several times in a day for the same traveling circumstance depending on the operations of the driver. On the other hand, if the driver operation information of the driver is learned for a longer span such as for several months, a trend for the long term may be learned by increasing or decreasing the current learning value whenever the deceleration greater than or less than a predetermined value is detected ten times, for example. In this case, the HMI which is not customized so frequently can be provided. The navigation apparatus 100 according to the present embodiment can be adapted for any learning speed. For example, a parameter for setting the learning speed (fast, middle and slow) is displayed on the display part 28. In this case, the driver can select a desired learning speed among these options. An index of a period at which the HMI is customized is several hours in the case of the learning speed being “fast”, a week in the case of the learning speed being “middle” and several months in the case of the learning speed being “slow”.

[Customization of HMI]

The HMI generating part 24 refers to the driver characteristics database 25 based on the circumstance information and outputs the HMI optimal for the driver on the display part 28.

Strictly speaking, the operation button (the operation button G, for example) different from the operation buttons A, D and E may be displayed even if it is limited due to the operation limitation during driving in predetermined driving situations where the vehicle travels in a forward direction and a backward direction, searching for parking area again, etc. Thus, the HMI may be customized on a traveling circumstance basis; however, in fact the operation buttons A, D and E may be common under many traveling circumstances. In the present embodiment, for the sake of simplicity, the operation limitation during driving permits only the operation buttons A, D and E to be operable. Using this limit level of the operation limitation during driving as “0”, the limit level is determined based on the current learning value of the degree of momentary lapses of attention or the degree of haste.

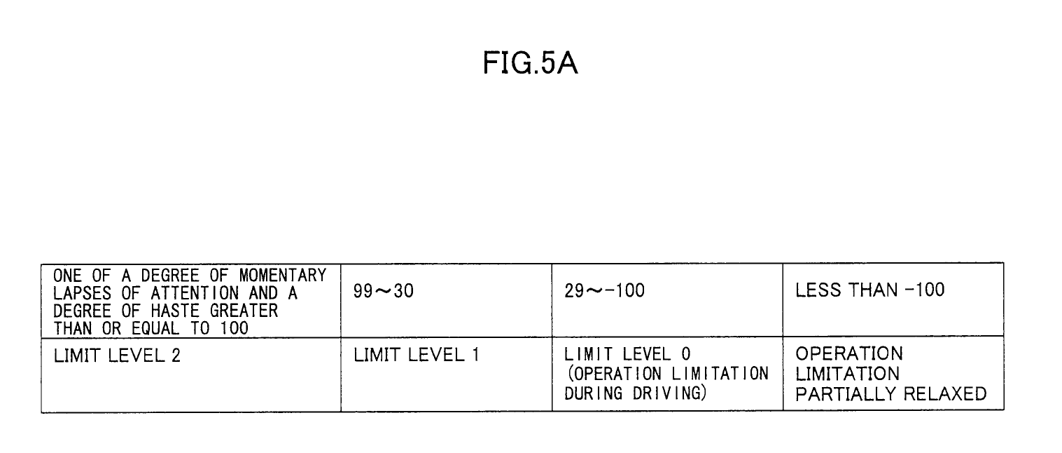

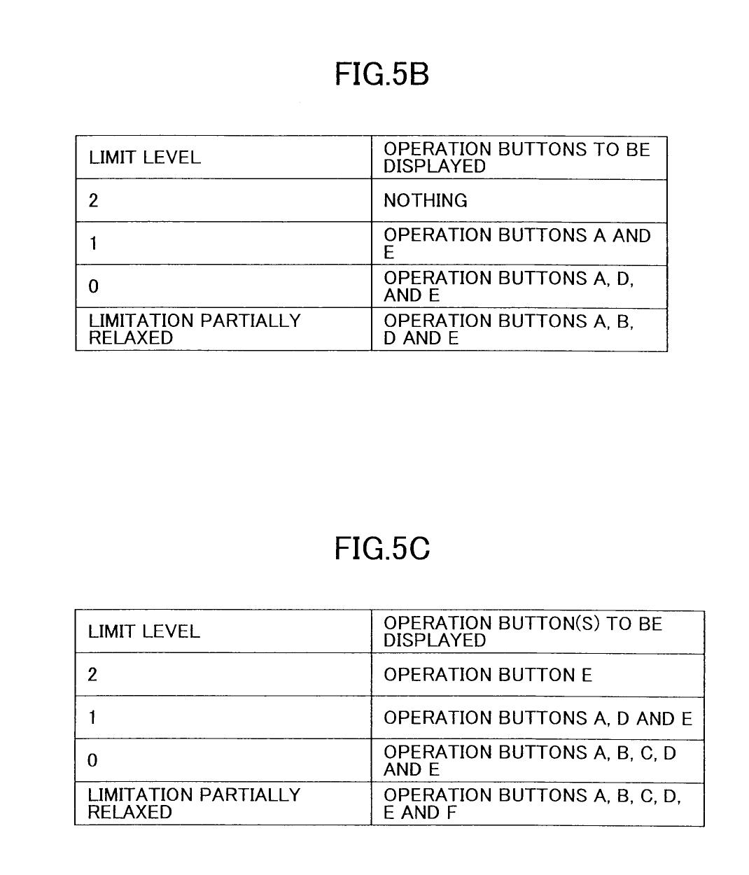

FIG. 5A is a diagram for illustrating an example of the limit level table 26 which defines a relationship between a current learning value of a degree of momentary lapses of attention or a degree of haste and a limit level. The greater the limit level is, the more limitation the HMI is subject to. The limit level table 26 is stored in the nonvolatile memory of the control part 20. As shown in FIG. 5A, the limit level is set to “2” if the current learning value of the degree of momentary lapses of attention or the degree of haste is greater than or equal to a predetermined value (100, in this example), the limit level is set to “1” if the current learning value of the degree of momentary lapses of attention or the degree of haste is between 30 and 99, and the limit level is set to “0” if the current learning value of the degree of momentary lapses of attention or the degree of haste is between −100 and 29. Thus, if the current learning value of the degree of momentary lapses of attention or the degree of haste is between −100 and 29, the same buttons as is the case with operation limitation during driving are displayed.

Further, the fact that the current learning value of the degree of momentary lapses of attention or the degree of haste is a negative value shows that the driver keeps cool in driving. Thus, in the case of being less than or equal to a predetermined value (less than or equal to −100, in this example), it is defined that the operation limitation during driving is partially relaxed.

The limit level table 26 as shown in FIG. 5A is registered on an item basis of the driver characteristics database 25 shown in FIGS. 3A-3C and FIGS. 4A-4D (i.e., a location in general, an intersection, during the night, at the time of raining, at the time of snowing, etc). Thus, the relationship between the current learning value and the limit level may be changed on an item basis. It is noted that the sum of the respective items may be associated with the limit level. In this case, the limit level is determined according to the degree of momentary lapses of attention or the degree of haste and regardless of the circumstance situation.

The HMI generating part 24 determines the limit level by referring to the limit level table 26 based on the current learning value of the degree of momentary lapses of attention and the current learning value of the degree of haste in the driver characteristics database 25. How to reflect the determined limit level on the HMI is predetermined in the HMI definition table 27 on an “operation limitation during driving” basis.

FIG. 5B is a diagram for illustrating an example of the HMI definition table 27 which defines a relationship between a limit level and an operation button to be displayed (operation limitation during driving: operation buttons A, D and E). The HMI definition table 27 is stored in the nonvolatile memory of the control part 20. In the operation limitation during driving with respect to the operation buttons A, D and E, the operation buttons A, D and E are not displayed in the case of the limit level being “2”, only the operation buttons A and E are displayed in the case of the limit level being “1”, and the operation buttons A, D and E are displayed in the case of the limit level being “0”. Further, in a cool status where the degree of momentary lapses of attention or the degree of haste is less than a predetermined value, the operation limitation during driving is partially relaxed and thus the operation button B is displayed.

FIG. 5C is a diagram for illustrating another example of the HMI definition table 27 which defines a relationship between a limit level and an operation button to be displayed (operation limitation during driving: operation buttons A, B, C, D and E). In the case of the operation buttons A, B, C, D and E being displayed under the operation limitation during driving, only the operation button E is displayed in the case of the limit level being “2”, only the operation buttons A, D and E are displayed in the case of the limit level being “1”, and the operation buttons A, B, C, D and E are displayed in the case of the limit level being “0”. Further, in a cool status where the degree of momentary lapses of attention or the degree of haste is less than a predetermined value, the operation limitation during driving is partially relaxed and thus the operation button F is displayed.

In this way, the more complicated the operation of the operation button is, the more difficult to be displayed the operation button is. Thus, it is possible to reduce the driving load of the driver who is under momentary lapses of attention or who is in haste.

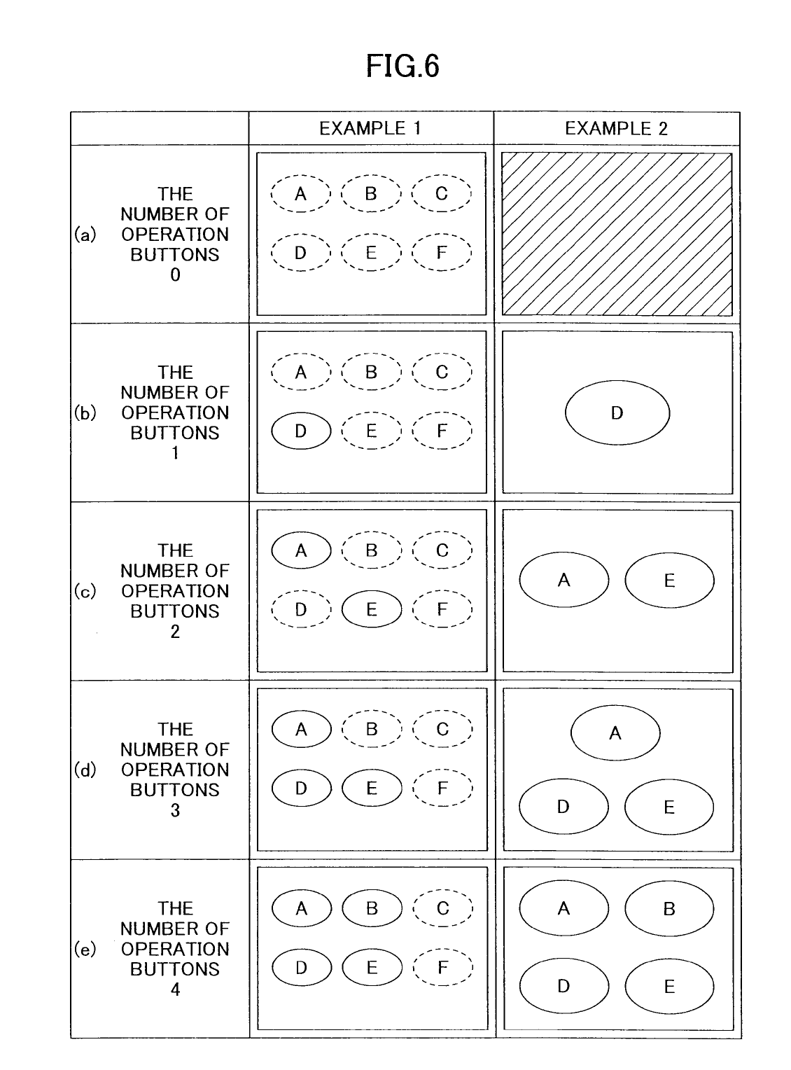

Once the number of the operation buttons to be displayed is determined, it may be sufficient to provide the HMI in which the operability and the design are considered. If the size of the respective operation buttons is the same, the resultant HMI can be determined by the number of the operation buttons. FIG. 6 is a diagram for schematically showing an example of a relationship between the number of buttons and the HMI. In FIG. 6, a row (a) shows an example of the HMI in the case of the number of the operation buttons being zero. As shown in the left side of the row (a), in the case of the number of the operation buttons being zero, all the operation buttons are displayed in lesser tone. Since the operation buttons are displayed in lesser tone, the driver can see the respective operation buttons. But, the corresponding functions are not provided even if the operation buttons are operated. If the operation buttons are displayed in lesser tone only, the positions of the operation buttons are not changed. Thus, the driver can view the navigation apparatus without feeling abnormal.

Further, as shown in the right side of the row (a), instead of displaying the operation buttons in lesser tone, the inoperable operation buttons may not be displayed. In fact the road map or the like is displayed; however, since no operation button is displayed, the driver does not try to operate the buttons and thus the driving load is reduced.

Similarly, a row (b) shows an example of the HMI in the case of the number of the operation buttons being 1, a row (c) shows the HMI in the case of the number of the operation buttons being 2, a row (d) shows an example of the HMI in the case of the number of the operation buttons being 3, and a row (e) shows an example of the HMI in the case of the number of the operation buttons being 4. The examples in the left side of the rows (b)-(e) show examples of the HMI in which the operation buttons other than the displayed operation button(s) are displayed in lesser tone. The examples in the right side of the rows (b)-(e) show the HMI in which only the operable operation button(s) are displayed in an enlarged size in the screen. It is noted that the driver may select the setting between the HMI displaying operation button(s) in lesser tone and the HMI displaying an enlarged operation button(s).

In the case of the HMI displaying an enlarged operation button(s), a luminance or a color of the displayed operation button(s) may remain as it is; however, in terms of reducing the operation load of the driver, it is preferable to increase a luminance or a color saturation so as to improve visibility for the driver.

It is noted that a file which predetermines the HMI may be stored for each combination of the operation buttons shown in FIG. 5B or FIG. 5C. With this arrangement, an expression of the HMI can be enriched by changing the size or the color of the respective operation buttons even in such a situation where the number of the operation buttons to be displayed is the same.

As described above, the navigation apparatus 100 according to the present embodiment improves the operability because it can customize the HMI on a driver basis. Since the customization of the HMI is implemented for the same driver, the operation load of the driver who gets tired and is under the momentary lapses of attention can be reduced by reducing the number of the operation buttons. Further, if the driver characteristics learning part 23 has learned that the driver, who could not keep cool in driving at the beginning, can keep cool in driving several months thereafter, the number of the operation buttons to be displayed can be increased for the driver. In this way, the HMI can be customized flexibly according to the driver characteristics.

[Operation Procedure of Navigation Apparatus 100]

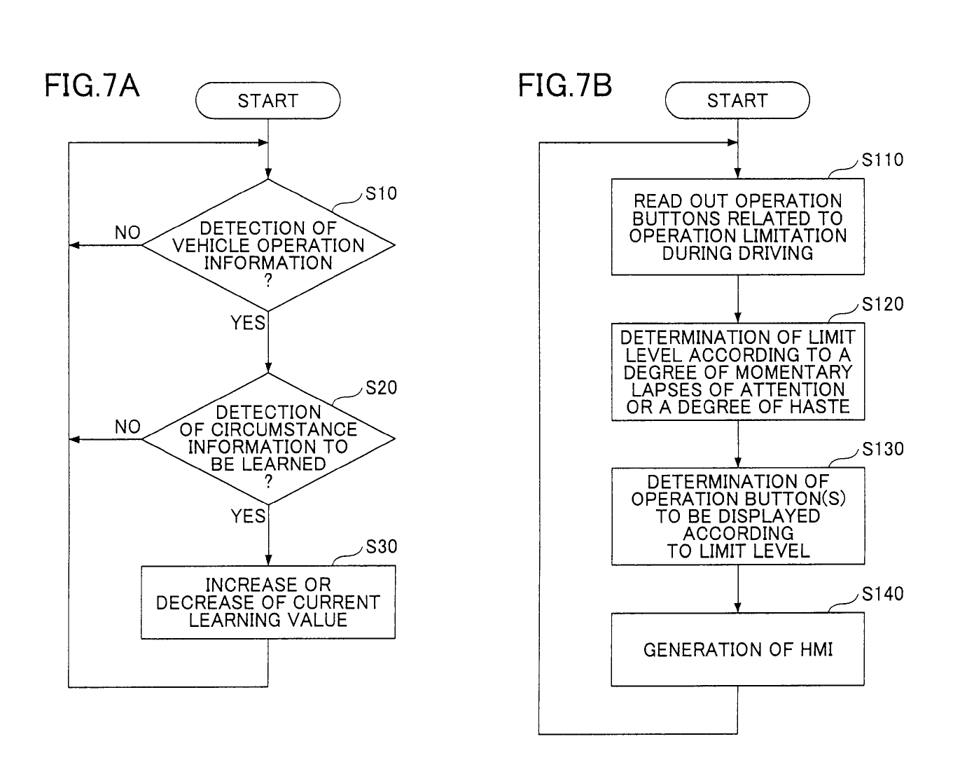

FIG. 7A is a flowchart of an example of a procedure by which the navigation apparatus 100 learns the driver characteristics and FIG. 7B is a flowchart of an example of a procedure by which the HMI is customized according to the learned result. The procedures shown in FIG. 7A and FIG. 7B are executed every predetermined cycle time.

The driver operation information obtaining part 21 determines whether it detects the driver operation information. The driver operation information is operations of the navigation screen, operations related to decelerating, accelerating, turning on the front lamps, steering, etc. If the driver operation information obtaining part 21 detects the driver operation information (Yes in S10), it is determined whether the circumstance information to be learned according to the driver operation information is detected (S20). For example, if there is a mistake in the navigation operations, the current learning value is increased or decreased regardless of the position of the vehicle. Further, if the front lamps are turned on at the time of passing through the tunnel, the current learning value is increased or decreased. It is noted that the process of S10 and the process of S20 are in no particular order. For example, the circumstance information may be detected first in S20 in order to detect the driver operation information that the temporary stop is not performed, such as the presence or absence of the temporary stop at the railroad crossing.

If the circumstance information is detected, the driver characteristics learning part 23 increases or decreases the current learning value associated with the driver operation information and the circumstance information (S30). The navigation apparatus 100 repeats the above described processes.

The HMI generating part 24 customizes the HMI on a driver basis based on the current learning value thus learned. First, the HMI generating part 24 reads out the predetermined operation buttons related to the operation limitation during driving (S110).

Next, the HMI generating part 24 refers to the limitation level table 26 to determine the limitation level according to the degree of momentary lapses of attention or the degree of haste (S120). The HMI generating part 24 determines the operation buttons to be displayed according to the limitation level (S130). The HMI generating part 24 generates the final HMI according to the number of the operation buttons (S140).

As described above, the navigation apparatus 100 according to the present embodiment improves the operability because it can customize the HMI according to the driver characteristics.

It is noted that in the present embodiment the customization of the HMI at the time of traveling of the vehicle is described; however, the HMI at the time of stopping of the vehicle can be customized. At the time of stopping of the vehicle all the operation buttons A-E are displayed; however, under a situation where the vehicle restarts traveling immediately after the stopping of the vehicle (waiting at traffic light, a traffic jam, for example), the vehicle restarts traveling immediately after the drivers starts the navigation operations. For this reason, for example, the HMI generating part 24 displays all the operation buttons A-E only if the HMI generating part 24 predicts that the stopping time is greater than or equal to a predetermined value, and otherwise limits the operable operation buttons as is the case of traveling. With this arrangement, for the driver whose degree of momentary lapses of attention or the degree of haste is high, only the operation button(s) which can be operated without any complicated operations is displayed if there is not enough time to complete the navigation operations during stopping (even if the parking brake is operated). This can reduce the operation load of the driver. The stopping time greater than or equal to the predetermined value is detected based on a time until the traffic light turns blue (or green), which is received via vehicle-road communication with the traffic signal; a distance of a traffic jam, which is received via vehicle-vehicle communication with other vehicle ahead in the traffic jam, etc.

The present application is based on Japanese Priority Application No. 2008-104733, filed on Apr. 14, 2008, the entire contents of which are hereby incorporated by reference.

1. A navigation apparatus which accepts an operation of an operation button displayed on a display part, said navigation apparatus comprising:
vehicle operation detecting means for detecting a vehicle operation;
vehicle operation obtaining means for obtaining driver operation information based on the vehicle operation which the vehicle operation detecting means detects;
driver characteristics learning means for learning driver characteristics of a driver based on the driver operation information; and
display manner changing means for changing a display manner of the operation button according to a learning result of the driver characteristics learning means.

2. The navigation apparatus claimed in claim 1, further comprising: vehicle circumstance detecting means for detecting a vehicle circumstance at the time of traveling; and
circumstance information obtaining means for obtaining vehicle circumstance information based on the vehicle circumstance which the vehicle circumstance detecting means detects, wherein
the driver learning means learns the driver characteristics of the driver based on the driver operation information in a predetermined vehicle circumstance.

3. The navigation apparatus claimed in claim 1, wherein in the case of plural operation buttons being displayed,
the display manner changing means displays, based on the learning result, the operation buttons in such a manner that the operation buttons whose number is less than the number of the operation buttons in an initial setting displayed at the time of traveling is displayed in a selectable manner.

4. The navigation apparatus claimed in claim 1, wherein in the case of plural operation buttons being displayed,
the display manner changing means displays, based on the learning result, the operation buttons in such a manner that the operation button, which is not selectable by a passenger, among the operation buttons in an initial setting displayed at the time of traveling is displayed in less tone than the operation button which is selectable.

5. The navigation apparatus claimed in claim 1, wherein in the case of plural operation buttons being displayed,
the display manner changing means displays, based on the learning result, the operation buttons in such a manner that the operation buttons whose number is more than the number of the operation buttons in an initial setting displayed at the time of traveling is displayed in a selectable manner.

6. The navigation apparatus claimed in claim 3, wherein the driver characteristics learning means learns a degree of momentary lapses of attention or a degree of haste of the driver,
the display manner changing means displays in such a manner that the greater the degree of momentary lapses of attention or the degree of haste becomes, the less number of the operation buttons is displayed in a selectable manner.

7. An operation part display method for a navigation apparatus which accepts an operation of an operation button displayed on a display part, said navigation apparatus comprising:
a step in which vehicle operation detecting means detects a vehicle operation;
a step in which vehicle operation obtaining means obtains driver operation information based on the vehicle operation which the vehicle operation detecting means detects;
a step in which driver characteristics learning means learns driver characteristics of a driver based on the driver operation information; and
a step in which display manner changing means changes a display manner of the operation button according to a learning result of the driver characteristics learning means.

8. The navigation apparatus claimed in claim 1, wherein the vehicle operation for driving a vehicle is a vehicle operation of accelerating, decelerating or steering, or a vehicle operation at the time of traveling required in terms of statute or safety.

9. The navigation apparatus claimed in claim 1, wherein
the vehicle operation detecting means detects an operation of the operation button, and
the vehicle operation obtaining means obtains the driver operation information based on the operation of the operation button which the vehicle operation detecting means detects.

10. The navigation apparatus claimed in claim 9, wherein the driver characteristics learning means learns the driver characteristics of the driver by converting a frequency of the operation of the operation button into numbers.
